(19) United States
(12) Patent Application Publication
(10) Pub. No.: US 2024/0297770 A1
(43) Pub. Date: Sep. 5, 2024

(54) IDENTIFICATION OF A SLOT FOR SOUNDING SIGNAL TRANSMISSION

(71) Applicant: QUALCOMM Incorporated, San Diego, CA (US)

(72) Inventors: Muhammad Sayed Khairy ABDELGHAFFAR, San Jose, CA (US); Alexandros MANOLAKOS, Escondido, CA (US); Peter GAAL, San Diego, CA (US); Yu ZHANG, San Diego, CA (US)

(21) Appl. No.: 18/262,565

(22) PCT Filed: Mar. 27, 2021
(86) PCT No.: PCT/CN2021/083456

§ 371 Date: Jul. 21, 2023

(51) Int. Cl. H04L 5/00

(52) U.S. Cl. CPC H04L 5/0094; H04L 5/0051; H04L 5/0096

(57) ABSTRACT

A user equipment (UE) may be configured to transmit sounding reference signals to sound over ports of a channel. The UE may be configured to receive a message to trigger transmission of at least one sounding reference signal (SRS) of at least one SRS resource set for sounding over an active bandwidth part (BWP) in an upcoming slot, the upcoming slot being offset by a number of available slots from a reference slot indicated by the message. The UE may be further configured to detect a gap in which operation for the active BWP is suspended occurring before the transmission of the at least one SRS of the at least one SRS resource set is complete.

### BACKGROUND

### Technical Field

The present disclosure generally relates to communication systems, and more particularly, to a user equipment that transmits reference signals to sound over bandwidth parts.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In access networks of some example radio access technologies (RATs), such as a 5G New Radio (NR) access network, a base station may estimate at least one channel on which transmissions are received from a user equipment (UE) (e.g., an uplink channel) using at least one sounding reference signal (SRS). Additionally or alternatively, SRS can be used for uplink frequency selective scheduling and/or uplink timing estimation.

Accordingly, the UE transmits the at least one SRS to the base station. In so doing, the UE may sound all ports of an SRS resource in each symbol of the SRS resource. In some aspects, the UE may aperiodically transmit SRSs in an SRS resource set, with such aperiodic SRS transmissions being triggered by the base station, for example, via downlink or uplink downlink control information (DCI) (e.g., SRS request field).

When the base station triggers transmission of an SRS resource set, the UE may some amount of delay may be unavoidable, e.g., as the UE may consume some time period while decoding and processing the triggering message, as well as switching to transmit from receive circuitry. Accordingly, the time at which the UE transmits an SRS resource set may not immediately follow the trigger. Instead, the point at which the UE transmits the SRS resource may be configured.

For example, the UE may be configured with a slot offset upon which the UE may base transmission of the SRS resource set after having been triggered. The UE may transmit the SRS resource set when the UE reaches the offset location.

In some instances, however, the UE may be configured such that the UE is unable to transmit the SRS resource set during a time that corresponds to the offset location. Thus, a need exists for approaches to SRS transmission when the timeline established for such SRS transmission is affected by one or more other factors. The present disclosure provides various techniques and solutions to SRS transmission in instances in which SRS transmission by the UE is complicated, prevented, delayed, etc. due to an intervening gap occurring before the offset location is reached or before the SRS transmission is completed.

In an aspect of the disclosure, a method, a computer-readable medium, and an apparatus are provided. The apparatus may be configured to receive a message to trigger transmission of at least one SRS of at least one SRS resource set for sounding over an active bandwidth part BWP in an upcoming slot, the upcoming slot being offset by a number of available slots from a reference slot indicated by the message. The apparatus may be further configured to detect a gap in which operation for the active BWP is suspended occurring before the transmission of the at least one SRS of the at least one SRS resource set is complete.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a diagram illustrating an example of a base station and user equipment (UE) in an access network.

FIG. 4 is a diagram illustrating an example of a base station and UE in a radio access network.

FIGS. 5A and 5B are diagrams illustrating slots used for triggering and transmitting an SRS resource set.

FIG. 6 is a diagram illustrating an intervening gap in slots used for triggering and transmitting an SRS resource set.

FIGS. 7A, 7B, and 7C are diagrams illustrating some examples of intervening gaps that may occur in sets of slots used for triggering and transmitting an SRS resource sets.

FIGS. 8A, 8B, and 8C are diagrams illustrating some other examples of intervening gaps that may occur in sets of slots used for triggering and transmitting SRS resource sets.

FIG. 9 is a diagram illustrating an intervening gap in slots used for transmitting an SRS resource set.

FIG. 10 is a flowchart of a method of wireless communication by a UE.

FIG. 11 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

In access networks of some example radio access technologies (RATs), such as a 5G New Radio (NR) access network, a base station may estimate at least one channel on which transmissions are received from a user equipment (UE) (e.g., an uplink channel) using at least one sounding reference signal (SRS). Additionally or alternatively, SRS can be used for uplink frequency selective scheduling and/or uplink timing estimation.

Accordingly, the UE transmits the at least one SRS to the base station. In so doing, the UE may sound all ports of an SRS resource in each symbol of the SRS resource. In some aspects, the UE may aperiodically transmit SRSs in an SRS resource set, with such aperiodic SRS transmissions being triggered by the base station, for example, via downlink or uplink downlink control information (DCI) (e.g., SRS request field).

When the base station triggers transmission of an SRS resource set, the UE may some amount of delay may be unavoidable, e.g., as the UE may consume some time period while decoding and processing the triggering message, as well as switching to transmit from receive circuitry. Accordingly, the time at which the UE transmits an SRS resource set may not immediately follow the trigger. Instead, the point at which the UE transmits the SRS resource may be configured.

For example, the UE may be configured with a slot offset upon which the UE may base transmission of the SRS resource set after having been triggered. The UE may transmit the SRS resource set when the UE reaches the offset location.

In some instances, however, the UE may be configured such that the UE is unable to transmit the SRS resource set during a time that corresponds to the offset location. Thus, a need exists for approaches to SRS transmission when the timeline established for such SRS transmission is affected by one or more other factors. The present disclosure provides various techniques and solutions to SRS transmission in instances in which SRS transmission by the UE is complicated, prevented, delayed, etc. due to an intervening gap occurring before the offset location is reached or before the SRS transmission is completed.

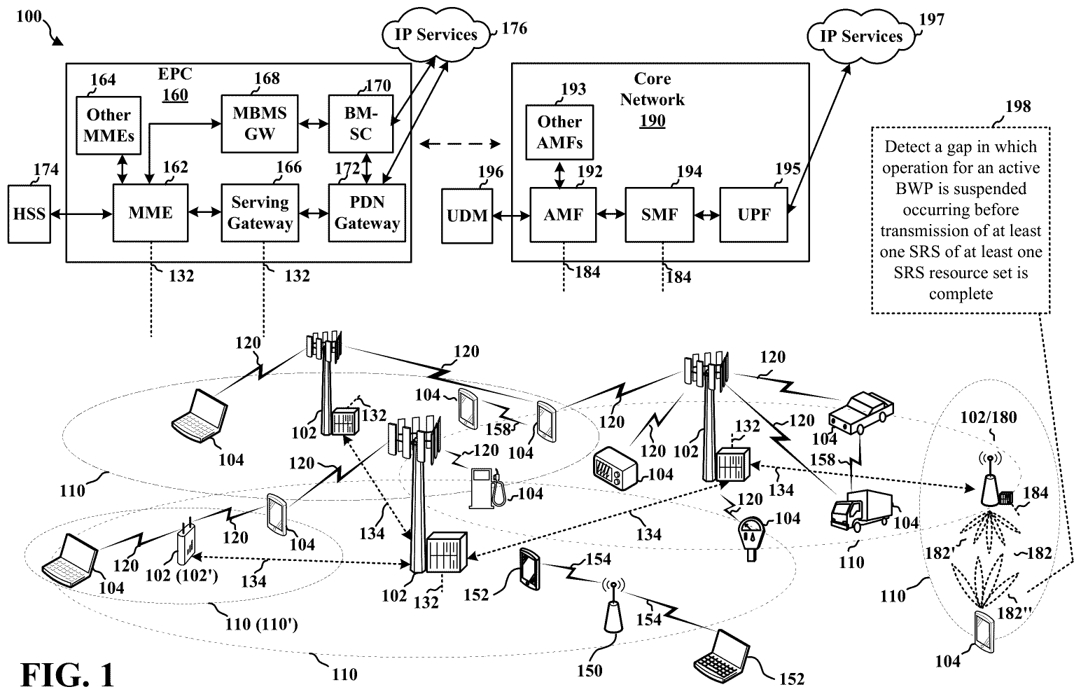

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR, which may be collectively referred to as Next Generation radio access network (RAN) (NG-RAN), may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless. At least some of the base stations 102 may be configured for integrated access and backhaul (IAB). Accordingly, such base stations may wirelessly communicate with other such base stations. For example, at least some of the base stations 102 configured for IAB may have a split architecture that includes at least one of a central unit (CU), a distributed unit (DU), a radio unit (RU), a remote radio head (RRH), and/or a remote unit, some or all of which may be collocated or distributed and/or may communicate with one another. In some configurations of such a split architecture, the CU may implement some or all functionality of a radio resource control (RRC) layer, whereas the DU may implement some or all of the functionality of a radio link control (RLC) layer.

Illustratively, some of the base stations 102 configured for IAB may communicate through a respective CU with a DU of an IAB donor node or other parent IAB node (e.g., a base station), further, may communicate through a respective DU with child IAB nodes (e.g., other base stations) and/or one or more of the UEs 104. One or more of the base stations 102 configured for IAB may be an IAB donor connected through a CU with at least one of the EPC 160 and/or the core network 190. In so doing, the base station(s) 102 operating as an IAB donor(s) may provide a link to the one of the EPC 160 and/or the core network 190 for other IAB nodes, which may be directly or indirectly (e.g., separated from an IAB donor by more than one hop) and/or one or more of the UEs 104, both of which may have communicate with a DU(s) of the IAB donor(s). In some additional aspects, one or more of the base stations 102 may be configured with connectivity in an open RAN (ORAN) and/or a virtualized RAN (VRAN), which may be enabled through at least one respective CU, DU, RU, RRH, and/or remote unit.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz, x component carriers (CCs) used for transmission in each direction. The carriers may or may not be adjacent to each other. Allocation of carriers may be asymmetric with respect to downlink and uplink (e.g., more or fewer carriers may be allocated for downlink than for uplink). The CCs may include a primary CC and one or more secondary CCs. A primary CC may be referred to as a primary cell (PCell) and a secondary CC may be referred to as a secondary cell (SCell).

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz. (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102″ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHZ-52.6 GHZ). The frequencies between FR1 and FR2 are often referred to as mid-band frequencies. Although a portion of FR1 is greater than 6 GHZ, FRI is often referred to (interchangeably) as a “sub-6 GHZ” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHZ” or the like if used herein may broadly represent frequencies that may be less than 6 GHZ, may be within FRI, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, a UE 104 may be triggered by a base station 102/180 to transmit at least one SRS of at least one SRS resource set. Although the UE 104 may experience some events that complicate or frustrate that SRS transmission. The UE 104 may be configured to receive a message to trigger transmission of at least one SRS of at least one SRS resource set for sounding over an active bandwidth part (BWP) in an upcoming slot. The upcoming slot may be offset by a number of available slots from a reference slot indicated by the message.

Further, the UE 104 may detect a gap in which operation for the active BWP is suspended that occurs before the transmission of the at least one SRS of the at least one SRS resource set is complete (198). Various aspects regarding operations by the UE 104 upon detecting such an intervening gap are described herein.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

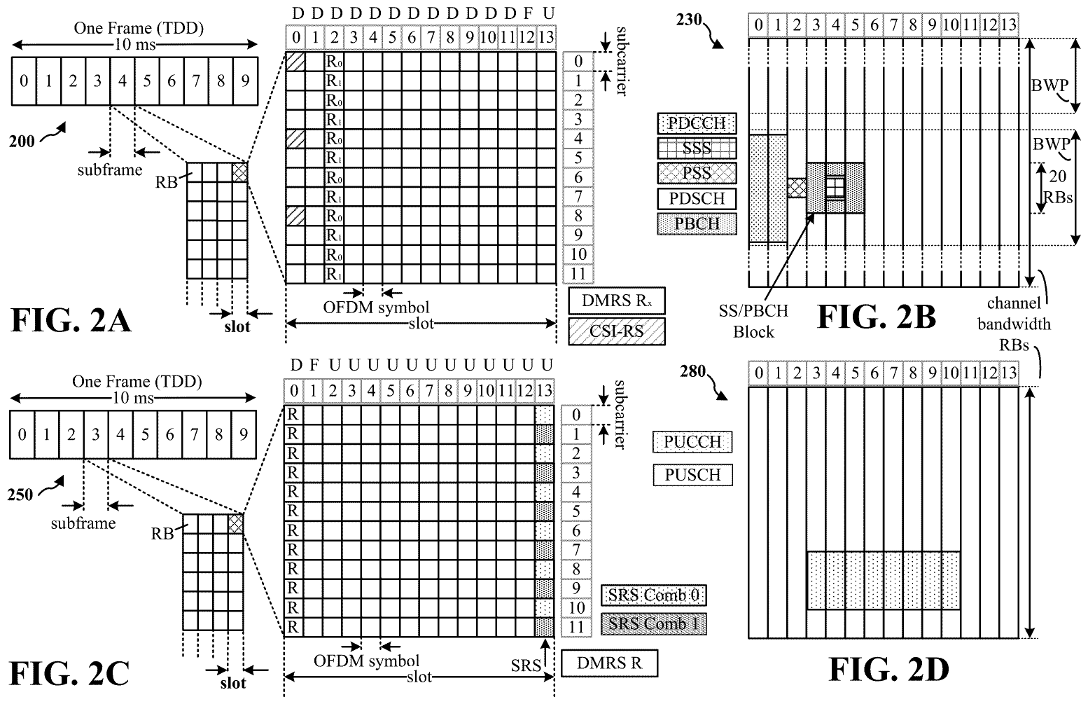

FIG. 2A is a diagram 200 illustrating an example of a first subframe within a 5G NR frame structure. FIG. 2B is a diagram 230 illustrating an example of downlink channels within a 5G NR subframe. FIG. 2C is a diagram 250 illustrating an example of a second subframe within a 5G NR frame structure. FIG. 2D is a diagram 280) illustrating an example of uplink channels within a 5G NR subframe. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A, 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through DCI, or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios: limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2^{μ} slots/subframe. The subcarrier spacing and symbol length/duration are a function of the numerology. The subcarrier spacing may be equal to 2ª * 15 kilohertz (kHz), where u is the numerology 0 to 4. As such, the numerology μ=0 has a subcarrier spacing of 15 kHz and the numerology μ=4 has a subcarrier spacing of 240 KHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (us). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot and/or reference signal (RS) for the UE. In some configurations, an RS may include at least one demodulation RS (DM-RS) (indicated as Rx for one particular configuration, where 100× is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit SRS. The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 2D illustrates an example of various uplink channels within a subframe of a frame. The PUCCH may be located as indicated in one configuration. The PUCCH carries uplink control information (UCI), such as a scheduling requests (SR), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

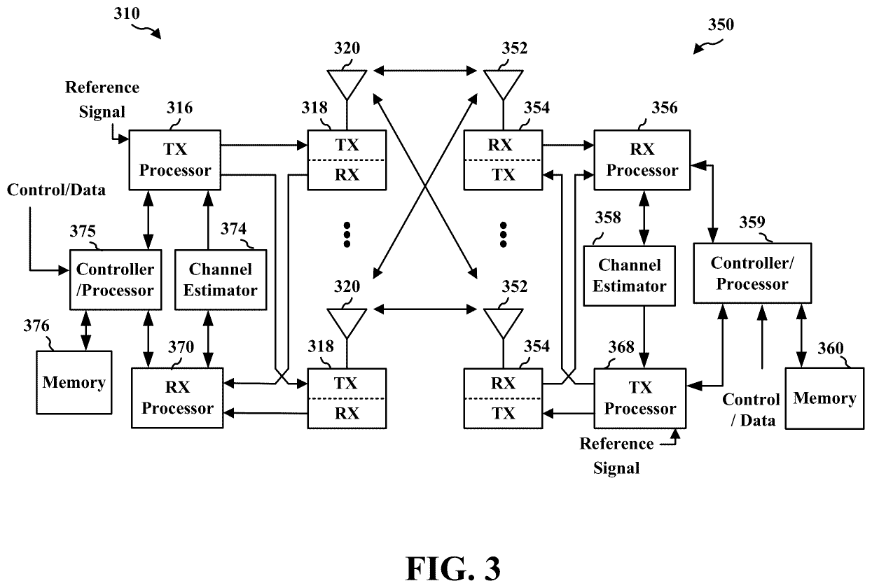

FIG. 3 is a block diagram of a base station 310 in communication with a UE 350 in an access network. In the downlink, IP packets from the EPC 160 may be provided to a controller/processor 375. The controller/processor 375 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter-RAT mobility, and measurement configuration for UE measurement reporting: PDCP layer functionality associated with header compression/decompression, security (ciphering, deciphering, integrity protection, integrity verification), and handover support functions: RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement Layer 1 (L1) functionality associated with various signal processing functions. L1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement L1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements L3 and L2 functionality.

The controller/processor 359 can be associated with a memory 360 that stores program codes and data. The memory 360 may be referred to as a computer-readable medium. In the uplink, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the downlink transmission by the base station 310, the controller/processor 359 provides RRC layer functionality associated with system information (e.g., MIB, SIBs) acquisition, RRC connections, and measurement reporting: PDCP layer functionality associated with header compression/decompression, and security (ciphering, deciphering, integrity protection, integrity verification): RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The uplink transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the uplink, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In some aspects, at least one of the TX processor 368, the RX processor 356, and the controller/processor 359 may be configured to perform aspects in connection with (198) of FIG. 1.

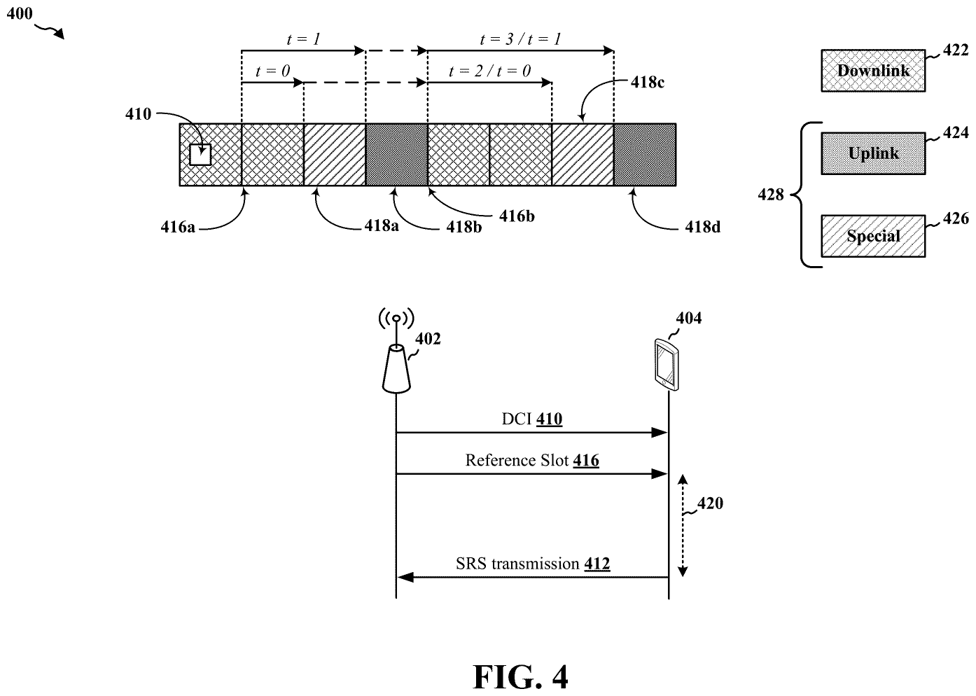

FIG. 4 is a diagram 400 illustrating an example of a base station 402 and UE 404 in a radio access network, in accordance with various aspects of the present disclosure. In an access network of an example RAT, such as a 5G NR access network, the base station 402 may estimate at least one channel on which transmissions are received from a UE 404 (e.g., an uplink channel) using at least one SRS, which corresponds to an SRS resource (although an SRS resource does not necessarily correspond to only one subcarrier over one symbol or an RE). The UE may transmit SRSs on one or more SRS resources, which may be included in an SRS resource set.

Thus, a UE 404 may transmit SRSs to a base station 402, and in so doing, all ports of an SRS resource are sounded in each symbol (see, e.g., FIGS. 2C-2D, supra). While the UE may transmit SRS in a slot including an uplink channel (e.g., PUSCH), the SRS may sound over a wider bandwidth than the uplink channel. For example, the UE may sound all ports on an active BWP (e.g., 10 MHZ, 20 MHZ, or 40 MHz bandwidth) by transmitting SRS on SRS resources of an SRS resource set.

According to various aspects, a slot (or other timing structure) may be configured to include SRS on a set of RBs spanning an entire active BWP configured by the base station 402 and for the UE 404. According to various aspects, the base station 402 may signal information associated with SRS configuration to the UE via RRC signaling, DCI (e.g., information included in DCI and/or a DCI Format), and/or a MAC control element (CE).

In the time domain, a slot may be configured to support SRS resources that span a certain number of symbols, which may be adjacent (e.g., 1, 2, or 4 adjacent symbols) with up to 4 ports per SRS resource. According to some aspects, an SRS may only be transmitted in the last 6 symbols of a slot (e.g., 5G NR Release 15 and Release 16 may support SRS transmission in the last 6 symbols of a slot). According to some other aspects, however, an SRS may be transmitted in any symbols of a slot—for example, 5G NR Release 17 and beyond potentially may support SRS transmission with more than 4 adjacent symbols (e.g., up to 8 symbols) in more than the last 6 symbols of a slot, such as all symbols of a slot.

In order to transmit on SRS resources, the SRS resources may be included in an SRS resource set for a UE. An SRS resource set contains sets of SRS resources on which one UE transmits. The UE 404 may be configured with multiple SRS resources, which may be grouped in an SRS resource set. An SRS resource set may be configured to include one SRS resource or multiple SRS resources, with the SRS resource(s) included therein being based on the use case for which the SRS is transmitted, such antenna switching, codebook-based, non-codebook-based, beam management, and the like. Illustratively, for SRS antenna switching use cases, 1 or 2 TX to 2 or 4 RX antenna switching may be supported, which may be denoted as “1T2R.” “2T4R,” “1T4R,” and “1T4R/2T4R” where a UE supports both 1 TX to 4 RX and 2 TX to 4 RX antenna switching (however, antenna switching in which the numbers of TX and RX are equal may also be supported).

To support antenna switching, an SRS resource set is configured with two (for 1T2R or 2T4R) or four (for 1T4R) SRS resources transmitted in different symbols. Each SRS resource includes one (for 1T2R or 1T4R) or two (for 2T4R) antenna port(s). The SRS port(s) of each SRS resource may be associated with different UE antenna port(s). However, other configurations may also be supported. For example, for 1T4R, two aperiodic SRS resource sets with a total of four SRS resources transmitted in different symbols of two different slots may be configured, instead of SRS resources 1 through 4 in one slot.

Scheduling of SRS transmission may be periodic, semi-persistent, or aperiodic. Accordingly, a UE may be configured for aperiodic, semi-persistent, or periodic transmission of an SRS resource set. For aperiodic transmission of an SRS resource set, the base station 402 may trigger SRS transmission by the UE 404 via DCI 410. In some aspects, two (2) bits in DL or UL DCI may trigger SRS transmission on SRS resources of an SRS resource set.

For example, the base station 402 may transmit the DCI 410 to the UE 404, and the DCI 410 may include a field designated as an “SRS request” field. The SRS request field may include a value (e.g., two bits) triggering SRS transmission by a UE 404. In some instances, the base station 402 may indicate an SRS resource set that the UE 404 is to use for SRS transmission. Illustratively, the UE 404 may be configured with one or more SRS resource sets for aperiodic SRS transmission, and each of the SRS resource sets may be associated with a respective value or other identifier, such as 1, 2, or 3. When the base station 402 triggers SRS transmission by the UE, the base station 402 may signal the respective value or other identifier corresponding to one of the SRS resource sets that the UE 404 is to use for aperiodic SRS transmission.

In order to trigger the UE 404 to use one SRS resource set, the base station 402 may first configure the UE 404 with the one or more SRS resource sets. The base station 402 may transmit information configuring each of the one or more SRS resource sets to the UE 404 via RRC signaling. In some aspects, each SRS resource set is configured via RRC signaling with two parameters, a first of which may identify the SRS resource set that the UE 404 is to use for SRS transmission and a second of which may identify additional SRS resource set(s) that the UE 404 may potentially use for SRS transmission.

In the context of some RATs, such as 5G NR, each of the first and second parameters may be included in one or more RRC messages as a respective field of an information element (IE), such as an SRS-Config IE. The first parameter may be associated with a field labeled aperiodicSRS-ResourceTrigger and may have a value of 1, 2, or 3, whereas the second parameter may be associated with a field labeled aperiodicSRS-ResourceTriggerList and may indicate an array of two values. Each value of the aforementioned fields may be referred to as a “code point.” By way of illustration, Table 1 illustrates potential code points that configure aperiodic SRS transmission using SRS resource set(s). Specifically, the code points may be conveyed as one of the following values in an SRS request field of DCI.

TABLE 1

| | Triggered aperiodic SRS | Triggered aperiodic SRS |
|---|---|---|
| | resource set(s) for DCI | resource set(s) for DCI |
| | format 0_1, 1_1, and 2_3 | format 2_3 configured |
| | configured with higher | with higher layer |
| Value of | layer parameter srs-TPC- | parameter srs-TPC- |
| SRS request | PDCCH-Group set to | PDCCH-Group set to |
| field | ‘typeB‘ | ‘typeA’ |
| 00 | No aperiodic SRS resource | No aperiodic SRS resource |
| | set triggered | set triggered |
| 01 | SRS resource set(s) | SRS resource set(s) |
| | configured with higher | configured with higher |
| | layer parameter | layer parameter usage in |
| | aperiodicSRS- | SRS-ResourceSet set to |
| | ResourceTrigger set to 1 | ‘antennaSwitching’ and |
| | or an entry in | resourceType in SRS- |
| | aperiodicSRS- | ResourceSet set to |
| | ResourceTriggerList set to | ‘aperiodic’ for a 1^{st} set of |
| | 1 | serving cells configured by |
| | | higher layers |
| 10 | SRS resource set(s) | SRS resource set(s) |
| | configured with higher | configured with higher |
| | layer parameter | layer parameter usage in |
| | aperiodicSRS- | SRS-ResourceSet set to |
| | ResourceTrigger set to 2 | ‘antennaSwitching’ and |
| | or an entry in | resourceType in SRS- |
| | aperiodicSRS- | ResourceSet set to |
| | ResourceTriggerList set to | ‘aperiodic’ for a 2^{nd} set of |
| | 2 | serving cells configured by |
| | | higher layers |
| 11 | SRS resource set(s) | SRS resource set(s) |
| | configured with higher | configured with higher |
| | layer parameter | layer parameter usage in |
| | aperiodicSRS- | SRS-ResourceSet set to |
| | ResourceTrigger set to 3 | ‘antennaSwitching’ and |
| | or an entry in | resourceType in SRS- |
| | aperiodicSRS- | ResourceSet set to |
| | ResourceTriggerList set to | ‘aperiodic’ for a 3^{rd} set of |
| | 3 | serving cells configured by |
| | | higher layers |

Turnaround time at the UE 404 is inherently non-instantaneous, and therefore, it may be impractical for the UE 404 to transmit an SRS resource set immediately upon receiving DCI 410 triggering the SRS resource set. Rather, the UE 404 may consume some amount of time by decoding the DCI 410, switching from receive circuitry to transmit circuitry, and other operations commensurate with a reception event-based transmission. In some contexts, this amount of time consumed by a UE may be referred to as a “UE timing condition,” or equivalently, a “minimum timing requirement,” although it will be appreciated that no requirement, minimum or otherwise, is imposed upon any aspects of the present disclosure by this language.

Additionally, the base station 402 or other entity in the access network or proximate to the UE 404 or base station 402 may find it undesirable for the UE 404 to immediately transmit an SRS resource set upon receiving a DCI trigger. For example, some degree of flexibility in scheduling a UE to transmit an SRS resource set may be desirable or beneficial in an access network. In view of the foregoing, the time at which the UE 404 transmits an SRS resource set may be offset from a reference slot 416.

In some aspects, the UE 404 may be configured with a reference slot 416 by the base station 402. For example, the base station 402 may transmit information to the UE 404 that indicates a reference slot occurring after the DCI 410 that triggers the SRS resource set. The base station 402 may transmit such information to the UE 404 via RRC signaling (although other types of signaling are also possible). In some other aspects, information regarding the reference slot 416, such as the position or an offset from slot that included DCI 410, may be stored in memory of the UE 404, e.g., as part of a wireless standard or protocol with which the UE 404 operates in conformance.

In some aspects, the reference slot 416 may be the slot the carrying the DCI triggering the SRS resource set. In the context of FIG. 4, for example, the first reference slot 416a may carry the DCI 410 and may also be the reference slot. In some other aspects, the reference slot 416 may be another slot other than the slot carrying the DCI. In the context of FIG. 4, for example, the fourth slot 416b may be an uplink slot 424 and so does not carry the DCI 410, but and may be a reference slot. Potentially, reference slots could be slots of any type—e.g., downlink slots 422, uplink slots 424, and special slots 426 could all be used as reference slots.

While the reference slot 416 may serve as the origin from which to measure an offset to SRS transmission, the application of such an offset may be a slightly more complex than simply counting an offset number of slots from the reference slot. Instead, the offset may be with respect to a number of “available” slots, which may exclude some portion of the slots that a UE sees before SRS transmission.

According to various aspects, an “available” slot is any slot in which a UE could theoretically transmit an SRS, and therefore, is any slot that meets the following two conditions: (1) the slot includes sufficient uplink or flexible symbol(s) to accommodate the time-domain location(s) for all the SRS resources in the SRS resource set; and (2) the slot is sufficiently subsequent to the reference slot that the UE timing condition is satisfied (e.g., so that a UE is able to transition from receive circuitry to transmit circuitry).

FIG. 4 illustrates four candidate slots at which the UE 404 may transmit at least one SRS of an SRS resource set 412. In some aspects, the SRS resource set 412 may be transmitted in a slot that is separated from the reference slot 416 by an offset 420, with the offset 420 being a number of available slots. Accordingly, an aperiodic SRS resource set may be transmitted in the (t+1)^{th} available slot counting from the reference slot 416. The offset 420 may be received by the UE 404 via RRC signaling (e.g., if only one value of t is configured in RRC) or DCI. The candidate values of the offset 420 may include zero, which may be the first available slot following the reference slot.

In one example, the reference slot 416 may be the first reference slot 416a, which is the slot that the base station 402 transmits the triggering DCI 410. The UE 404 may receive the triggering DCI 410, and the UE 404 may count the number of available slots 428 following the first reference slot 416a. The UE 404 may be configured by with base station 402 with the pattern of uplink/downlink/and special slots, e.g., via RRC signaling, so that the UE 404 is able to count the available slots. The UE 404 may receive, from the base station 402 via RRC signaling, a slot pattern showing a segment of downlink, uplink, and/or special slots arranged in a certain order, which may repeat for the UE 404 when operating on a cell provided by the base station 402.

For example, the UE 404 may find that the first available special slot 418a and the first available uplink slot 418b are each available slots 428 that the UE 404 may count toward the offset. However, if the offset is equal to zero or one, the UE 404 may transmit the at least one SRS of the SRS resource set 412 in the first slot 418a (if the offset is zero) or the second slot 418b (if the offset is one).

Potentially, the offset could be configured for the UE 404 to be equal to two or three or another number greater than three. However, the slot following the second available slot 418b is a downlink slot 422, and therefore, is not eligible to be counted. Instead, the UE 404 continues on in time, at which point the UE 404 may reach the third available slot 418c, and then the fourth available slot 418d, both of which may satisfy the abovementioned conditions. Therefore, if the offset were two, then the UE 404 may transmit the at least one SRS of the SRS resource set 412 in the third available slot 418c. If, however, the offset were three, then the UE 404 may transmit the at least one SRS of the SRS resource set 412 in the fourth available slot 418d, which is four available slots after the reference slot 416 that included the triggering DCI 410.

In another example, the reference slot 416 may be the second reference slot 416b, which may be any slot after the slot carrying the triggering DCI 410. The slot that the base station 402 transmits the triggering DCI 410. The UE 404 may receive the triggering DCI 410, and the UE 404 may count the number of available slots 428 following the second reference slot 416b. For example, the UE 404 may find that the third available slot 418c and the fourth available slot 418d are each available slots 428 that the UE 404 may count toward the offset. Accordingly, if the offset is equal to zero or one with the reference slot being positioned where the second reference slot 418d, the UE 404 may transmit the at least one SRS of the SRS resource set 412 in the third available slot 418c (if the offset is zero) or the fourth available slot 418d (if the offset is one).

When the UE 404 finds the available slot that is separated from the reference slot 416 by the offset 420, the UE 404 may transmit the SRS resource set 412. In some aspects, the UE 404 may perform some collision handling, e.g., if the SRS resource set 412 collides with other signaling at the offset slot. For example, the UE 404 may determine which of the SRS resource set 412 or the other signal has a higher priority relative to the other, and the higher priority of the two may be transmitted in the available slot.

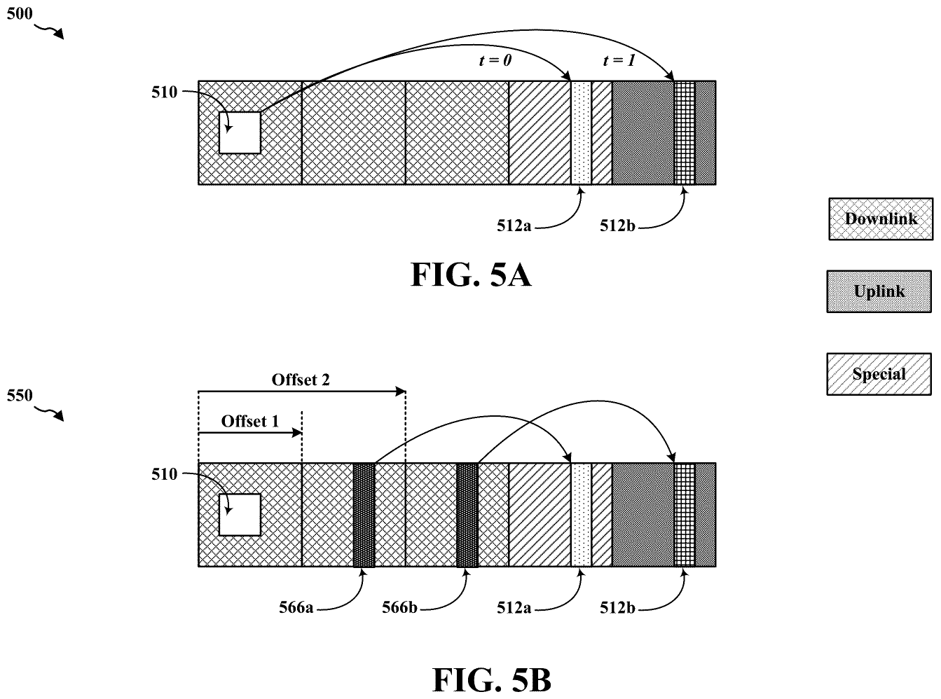

FIGS. 5A and 5B are diagrams illustrating slots used for triggering and transmitting an SRS resource set. A base station may transmit, and a UE may receive, the DCI 510, which may trigger transmission of an SRS resource set. The DCI 510, however, may trigger more than one SRS resource set. For example, as illustrated, the DCI 510 may trigger two the SRS resource sets 512a, 512b. The two SRS resource sets 512a, 512b may be non-overlapping in time, and therefore, the UE may be configured with a respective offset and/or reference slot for each of the multiple SRS resource sets 512a, 512b.

As shown in the diagram 500 of FIG. 5A, the offsets may be different between SRS resource sets triggered by the same DCI. Therefore, though the UE may be triggered for SRS transmission by the same DCI 510, the SRS resource sets 512a, 512b may be transmitted at separate locations. For example, the first SRS resource set 512a may be separated by an offset of zero from the reference slot, and so may be transmitted from the first available special slot following the reference slot. The second SRS resource set 512b, however, may be separated from the reference slot by an offset other than zero, such as an offset of one.

As shown in the diagram 550 of FIG. 5B, the reference slots may be different between SRS resource sets triggered by the same DCI. Therefore, though the UE may be triggered for SRS transmission by the same DCI 510, the SRS resource sets 512a, 512b may be transmitted at separate locations, and each may be configured with a different reference slot 566a, 566b. In some instances, the differences between reference slots 566a, 566b may be insufficient to separate SRS resource sets in time. In the illustrated aspects, for example, an SRS resource set would be transmitted at the same available slot if the triggering slot were to be any of the preceding three downlink (and unavailable) slots. Consequently, SRS resource sets may be configured with different transmission offsets. For example, the first SRS resource set 512a may be separated by an offset of zero from the reference slot, and so may be transmitted from the first available special slot following the reference slot. The second SRS resource set 512b, however, may be separated from the reference slot by an offset other than zero, such as an offset of one.

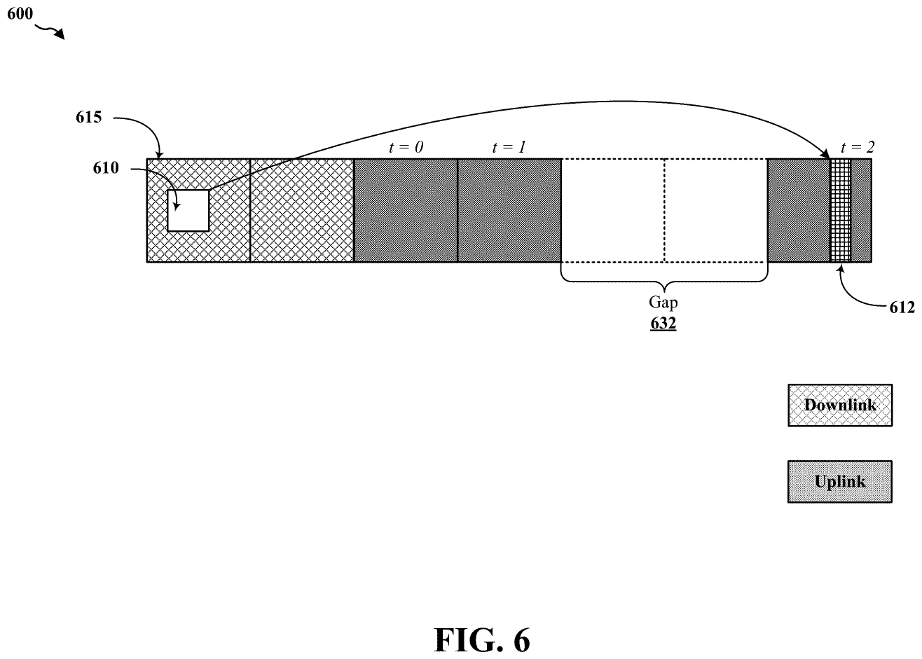

FIG. 6 is a diagram 600 illustrating an intervening gap 632 in slots used for triggering and transmitting an SRS resource set 612. In some instances, however, various communications and RAN features may appreciably impact SRS transmission, such as by disturbing the timeline a UE follows from reception of the triggering DCI to reference slot (if different from DCI slot) and through completion of transmission of an SRS resource set, which may include multiple repetitions of the SRS resource set over multiple consecutive slots. For example, the UE determination of available slot(s) after receiving triggering DCI may be affected by an intervening gap that occurs after receiving the triggering DCI. During the intervening gap, operation for an active BWP 615 may be suspended before transmission of the SRS resource set is complete.

The gap may draw the UE outside of the active BWP 615, e.g., so that the repeated slot pattern becomes inapplicable and/or so that the UE cannot transmit when the UE expected to do so. As illustrated by FIG. 6, an intervening gap 632 may occur after the DCI 610 is received to trigger the SRS resource set transmission. For example, if a UE is configured with an offset of t=2, but the intervening gap 632 occurs after the reference slot and before the (t+1)^{th} offset slot, then many slot the UE could miss available slots that occur during the gap 632, causing delays to SRS transmission.

According to various aspects, the UE may detect the gap 632 that occurs before the transmission of the SRS resource set is complete. For example, the UE may detect the gap 632 before the UE is able to locate and transmit an SRS resource set that is offset from a reference slot, or the UE may detect the gap 632 when a TX chain and/or other circuitry of the UE is unavailable.

In some aspects, the UE may treat the gap 632 as a set of non-available slots, and therefore, the UE may resume counting available slots at the conclusion of the gap 632. Accordingly, the UE may refrain from counting any slots during the gap 632, including where the gap 632 includes slots that would satisfy the UE timing condition and also includes sufficient time-domain resources to accommodate the entire SRS resource set 612.

The UE may find the offset slot in which to transmit the SRS resource set 612 by, first, counting the number of available slots up to the gap 632, and then resuming the count of the number of available slots when the gap 632 is over. In other words, the slot in which the UE may transmit the SRS resource set 612 may be offset by a sum equal to the number available slots from the reference slot to the gap 632, plus the duration of the gap 632, plus the number of available slots from the gap 632 until the offset is reached. When the gap 632 ends, the TX chain and/or other circuitry may be re-tuned to the active BWP 615 over which the UE is to sound, as indicated by the DCI 610. Accordingly, the UE may transmit the SRS resource set 612 to sound over the active BWP 615.

In some other aspects, however, the UE may be configured to cancel transmission of the SRS resource set 612 upon detecting the intervening gap 632. For example, the UE may determine that the gap 632 will sufficiently disrupt the sounding on the channel such that the UE should be re-triggered.

In some aspects, the UE may compare the duration of the gap 632 with a threshold. If the UE determines that the duration of the gap 632 satisfies (e.g., greater than or equal to) a threshold, then the UE may cancel transmission of the SRS resource set 612, as the sounding procedure may have timed out at the UE and/or the base station. If, however, the UE determines that the duration of the gap 832 fails to satisfy (e.g., less than) a threshold, then the UE may transmit the SRS resource set 612 to sound over the active BWP 615.

In some aspects, such a threshold may be contingent upon the capabilities of the UE, which the UE may report to the network in a UE capability message. For example, the UE report a capability to recover from intervening gaps (and so transmit an SRS resource set) of a duration no longer than x ms or y number of slots for each numerology (or subcarrier spacing). In some aspects, to the extent the base station is able to influence the gap 632, the base station may attempt to keep the gap below the indicated UE capability. In some other aspects, the threshold duration of the gap 632, after which SRS transmission is canceled, may be defined by a standard or protocol, such as a 3GPP standard or other similar wireless standard. Thus, the UE and the base station may each have the threshold gap duration store in memory.

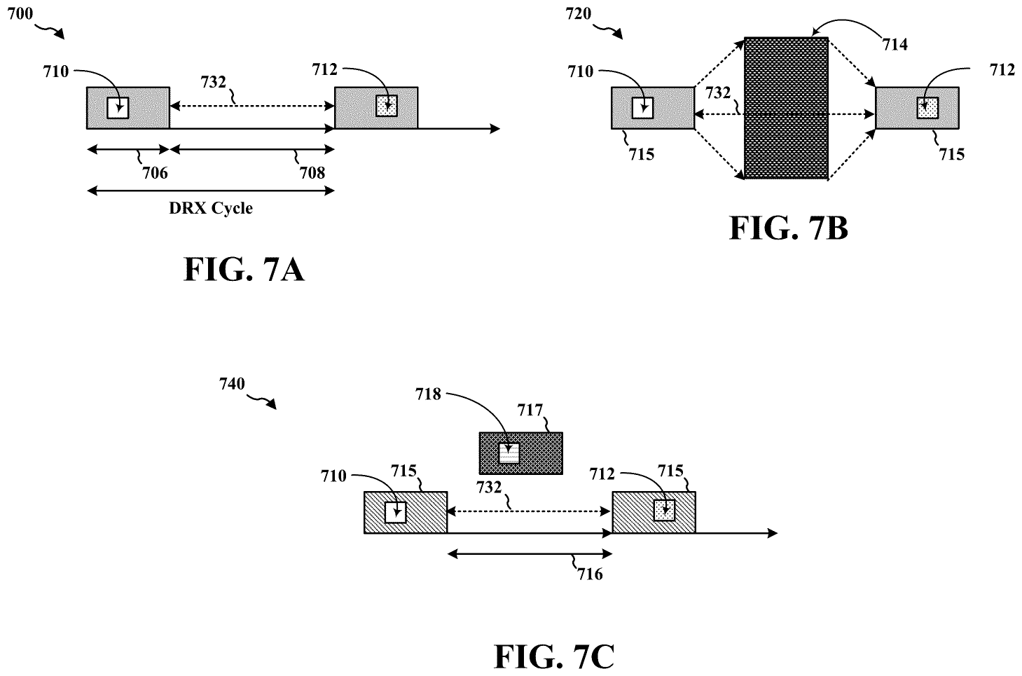

FIGS. 7A through 7C are diagrams 700, 720, 740 illustrating some examples of intervening gaps that may occur in sets of slots used for triggering and transmitting an SRS resource sets. First with respect to FIG. 7A, a 700 diagram illustrates a discontinuous reception (DRX) cycle with which a UE may be configured. The DRX cycle may be divided into an on duration 706 and an off duration 708, which may be repeated. In the on duration, the UE may operate as expected by monitoring the wireless channel and receiving and decoding information. Accordingly, the UE may receive DCI 710 while in the on duration, which may trigger transmission of an SRS resource set 712.

However, when the UE begins counting the available slots and/or finding the reference slot, the UE may be scheduled to be in a DRX off duration 708, which may introduce a gap 732 into the UE timeline for SRS transmission. In the off duration 708, the UE may be in a low power state, preventing the UE from counting or otherwise determining the available slots during that time. As the off duration 708 may be on the scale of tens or hundreds of milliseconds (e.g., rather than microseconds), the off duration 708 may introduce a gap 732 that is appreciably longer than the timeline according to which SRS transmission by the UE is expected.

Turning to FIG. 7B, a diagram 720 illustrates BWP switching with which a UE may be configured. While operating on a first active BWP 715, the UE may receive DCI 710 triggering transmission of an SRS resource set 712. However, when the UE begins counting the available slots and/or finding the reference slot, the operation on the active BWP 715 may be suspended while the UE is reconfigured onto another BWP 714. As the UE is configured onto another BWP 714 that is different from the first active BWP 715, which may differ from the first BWP 715 in terms of subcarrier spacing, etc., a gap 732 may interrupt the UE timeline for SRS transmission. While operating in the second BWP 714, the UE may be prevented from counting or otherwise determining the available slots during that time, e.g., as the slot pattern and structure may be different between the other BWP 714 and the initial BWP 715. As the other BWP 714 may differ from the first BWP 715, the UE may detect a gap 732 that is appreciably longer than the timeline according to which SRS transmission by the UE is expected.

Referring to FIG. 7C, a diagram 740 illustrates a measurement gap 716 with which a UE may be configured. While operating on a first active BWP 715, the UE may receive DCI 710 triggering transmission of an SRS resource set 712. However, when the UE begins counting the available slots and/or finding the reference slot, the operation on the active BWP 715 may be suspended while the UE performs some measurement and reporting in the measurement gap 716, such as radio resource management (RRM) and/or radio link monitoring (RLM) measurements.

The UE may perform measurements in the measurement gap 716 based on receiving at least one reference signal 718 on frequency resources 717 that are outside the active BWP 715, and therefore, the measurements may cause an intervening gap to the UE timeline for SRS transmission. During the time that the UE is performing measurements on the other frequency resources 717, the UE may be prevented from counting or otherwise determining the available slots in the first active BWP 715. Accordingly, the UE may detect a gap 732 of a length approximately equal to the measurement gap 716, which may cause delay to the transmission of the SRS resource set 712 by the UE.

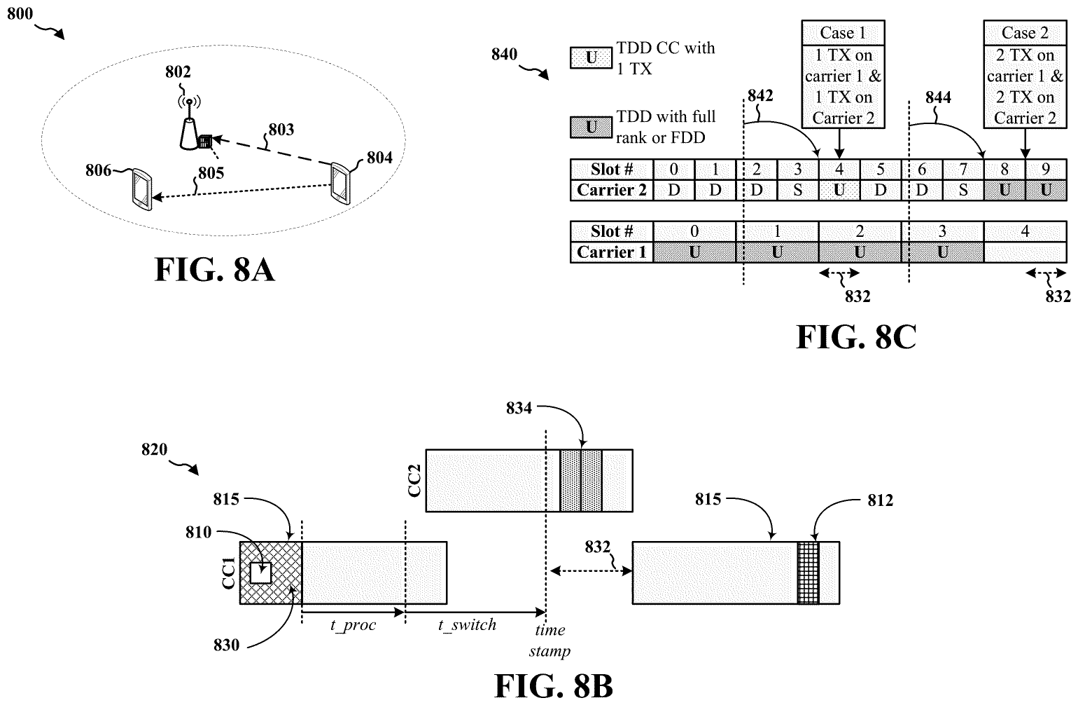

FIGS. 8A, 8B, and 8C are diagrams illustrating some other examples of intervening gaps that may occur in sets of slots used for triggering and transmitting SRS resource sets. With reference to FIG. 8A, a diagram 800 illustrates sidelink communication 805 in which a UE 804 may engage. For network communication 803, the UE 804 communicates with a base station 802, e.g., over the air interface or Uu interface. The network communication 803 may occur on an active BWP, which may be configured for the UE 804 by the base station 802. In this active BWP, the UE 804 may receive, from the base station 802, DCI triggering transmission of an SRS resource set.

The UE 804 also may have the capability to engage in some sidelink communication, e.g., on a PC5 interface or other interface different from the interface used for the network communication 803 with the base station 802. The sidelink communication 805 may not necessarily be coordinated with the base station 802, and potentially, may occur unexpectedly and/or unavoidably, for example, which may be seen with certain use cases, such as ultra-reliable low-latency communications (URLLC), and certain communications technologies, such as vehicle-to-everything (V2X). Therefore, there is some change that the sidelink communication 805 may interrupt sounding by the UE 804, specifically when the UE 804 is counting available slots from the reference slot for SRS transmission and/or finding the reference slot. The sidelink communication may be carried on a BWP that is different from the active BWP with which the UE 804 may be configured for the network communication 803.

The operation on the active BWP (for network communication 803) may be suspended while the UE 804 engages in the sidelink communication 805 with another UE 806 on a sidelink BWP. While the UE 804 participates in the sidelink communication 805 on the sidelink BWP rather than the network-configured BWP, a gap may interrupt the UE timeline for SRS transmission on the active BWP. While operating in the sidelink BWP, the UE 804 may be prevented from counting or otherwise determining the available slots during that time, e.g., as the slot pattern and structure may be different and/or unsynchronized between the active BWP and the sidelink BWP. Thus, the UE 804 may detect a gap resulting from the sidelink communication 805 that the UE 804 may not otherwise have experienced, which may increase the latency in SRS transmission.

Referring to FIG. 8B, a diagram 820 illustrates a SRS carrier switching with which a UE may be configured. While operating on a first active BWP 815 (e.g., CC1), the UE may find DCI 810 in the search space of a CORESET 830. The DCI 810 may be group-common (GC) DCI, which may be DCI of format 2_3, that instructs the UE to sound CCs on which neither the PUCCH nor the PUSCH is configured (e.g., CC2). The UE may adhere to this instruction, and so may switch from the active BWP 815 to the CCs indicated by the GC-DCI, CC2. In CC2, the UE may transmit a set of SRSs 834 to sound over CC2.

The DCI 810 or another DCI may also trigger the UE to sound over the active BWP 815, CC1. However, when the UE is to begin counting the available slots and/or finding the reference slot, the operation on the active BWP 815 may be suspended while the UE performs tunes to CC2 and sounds over CC2 with the SRSs 834, as instructed by the GC-DCI. While the UE may then switch back to the initial active BWP 815, the SRS carrier switching procedure in which the UE sounded over CC2 may have introduced some latency, as the time t_proc for the UE to decode and process the GC-DCI and the time t_switch for the UE to switch from receive circuitry to transmit circuitry and tune the circuitry from CC1 to CC2 may introduce cause some non-negligible overhead.

During the time that the UE is sounding over CC2, the UE may be prevented from counting or otherwise determining the available slots in the first active BWP 815. So while the UE may have been triggered to transmit an SRS resource set following an offset number of available slots from a reference slot. Accordingly, the UE may detect a gap 832 of a length of the time between the time stamp at which t_switch is completed and the time at which the UE resumes operation on the initial active BWP (although other instances may increase this duration, such as the processing time t_proc and/or the switching time t_switch), which may cause delay to the transmission of the SRS resource set 812 in the active BWP 815.

Referring to FIG. 8C, a diagram 840 illustrates uplink transmit (UL TX) switching with which a UE may be configured. A UE may be configured for UL TX switching in which a relatively lower band, such as n1 band at approximately 2100 MHz, is aggregated with a higher band, such as n78 at approximately 3700 MHZ, over multiple TX chains for uplink MIMO. UL TX switching may include 1TX-2TX switching-that is, dynamically switching between one TX chain concurrently on two carriers (mode 1) and two TX chains on two carriers, with one TX chain on one carrier and one TX chain on another carrier (mode 2). Such dynamic ITX-2TX switching may improve throughput in carrier aggregation between FDD and TDD, as well as E-UTRAN/NR Dual Connectivity (ENDC) in which a 5G carrier is aggregated with an LTE carrier, either with or without a supplementary uplink (SUL).

UL TX switching may allow two streams to on two carriers. For example, in case 1, a second TX chain may be provisioned at a time 842, at which time two TX chains may simultaneously stream on two carriers, with one TX chain streaming on an TDD carrier and the other streaming on an FDD carrier. In case 2, a second TX chain may be provisioned at time 844, at which time two TX chains may stream on the same carrier (e.g., TDD with full rank). Thus, in order for UL TX switching to function as intended, a second TX chain may be dynamically provisioned to one data stream on the same or another carrier.

In many instances, however, the second TX chain may be temporarily configured away from an active BWP configured. For example, the circuitry tuned to the active BWP in which the UE receives DCI triggering SRS transmission may be tuned to another carrier, such as the carrier to which a first TX chain is already tuned, or to a different carrier that is aggregated with a carrier to which the first TX chain is already tuned.

While such UL TX switching may increase throughput in some respects, a cost may be incurred in terms of latency or other overhead. While the TX chain otherwise configured on the active BWP is tuned to a carrier for UL TX switching, the some or all operations in the initial active BWP may be suspended. Thus, a gap 832 may interrupt the UE timeline for SRS transmission on the active BWP as a consequence of UL TX switching, as the UE may lack any equipment to hold a service. While operating in the sidelink BWP, the UE 804 may be prevented from counting or otherwise determining the available slots during that time, e.g., as the slot pattern and structure may be different and/or unsynchronized between the active BWP and the sidelink BWP. Thus, the UE 804 may detect a gap 832 resulting from a TX chain configured for the initial active BWP being reconfigured for UL TX switching with another TX chain on two carriers at a first time 842 and/or on one carrier at a second time 844. As such a gap may affect the counting of available slots and identifying of an offset slot and/or a reference slot, the UE 804 may inadvertently increase in the latency in the sounding procedure by delaying SRS transmission.

An intervening gap (in time) between a slot carrying DCI triggering transmission of an SRS resource set and the time at which transmission of the SRS resource set is complete, similar to the gap 632 illustrated in FIG. 6, may be caused by additional and/or alternative means. The foregoing examples of FIGS. 7A through 7C, 8A through 8C, and 9 are intended to be illustrative and non-limiting, and a UE may detect gaps by additional and/or alternative approaches without departing from the scope of the present disclosure.

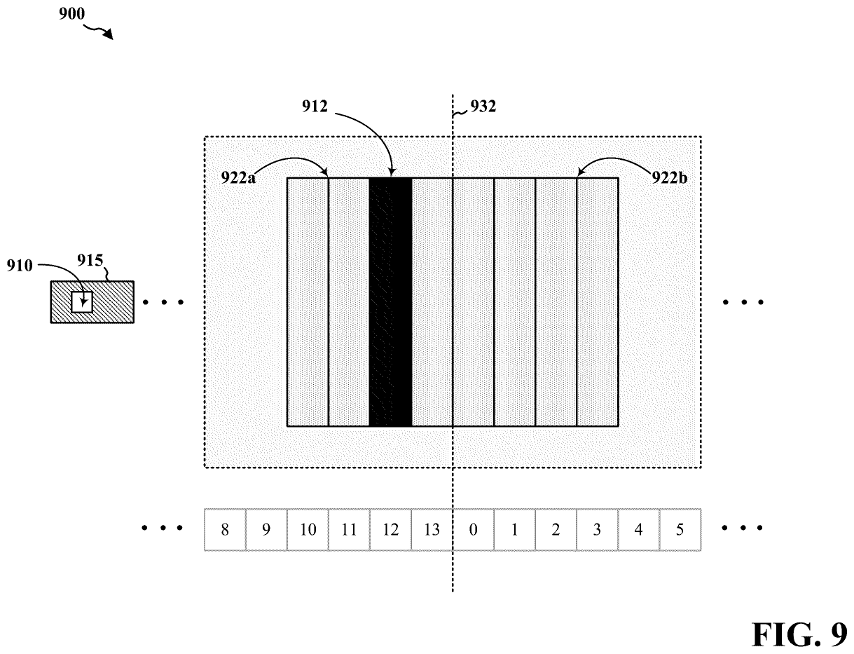

FIG. 9 is a diagram 900 illustrating an intervening gap 932 in between slots 922a, 922b used for transmitting an SRS resource set. According to some implementations, transmission of an SRS resource set may include transmission of multiple SRS resources that are repeated over a set of consecutive slots.

In FIG. 9, a UE may be configured to repeatedly transmit SRS resources over two or more consecutive slots on one or more BWPs. For example, the UE may receive DCI 910 that triggers transmission of multiple repetitions of the SRS resources. The UE may transmit SRS resources in a first slot 922a, as well as in a second slot 922b, e.g., for SRS repetition to ensure the entire BWP 915 is sounded over. Thus, in some configurations, the UE may transmit multiple repetitions of SRS resources 912 over multiple consecutive slots, e.g., such as the illustrated two slots 922a, 922b.

Before the UE completes transmission of the multiple SRS resource repetitions, the UE may detect a gap 932, which may intervene between SRS resources of two consecutive slots 922a, 922b. For example, the gap 932 may begin approximately at the slot boundary, and may be initiated by a BWP switch or DL communication. Consequently, repetitions of the SRS resources may no longer occur in consecutive slots.

In some aspects, the UE may transmit SRS resources 912 up until the start of the gap 932. Thereafter, the UE may cancel any remaining repetitions of the SRS resources, and may instead proceed with the other operations, such as those associated with the gap 932.

In some other aspects, the UE may cancel transmission of all repetitions of the SRS resources. For example, when the UE detects the gap 932 in advance of the offset slot at which the UE transmits the first SRS resource, the UE may determine that all SRS resources should canceled. Accordingly, the UE may halt any transmissions of the SRS resources that would have been interrupted by the gap 932.

In still other aspects, the UE may treat the gap 932 as a pause in the transmission of repetitions of the SRS resources. That is, the UE may transmit SRS resources up until the start of the gap 932, and then the UE may pause the transmission of repetitions of the SRS resources for the duration of the gap 932. When the gap 932 is over, the UE may resume transmission of any remaining repetitions of the SRS resources at the next slot at which the UE may do so.

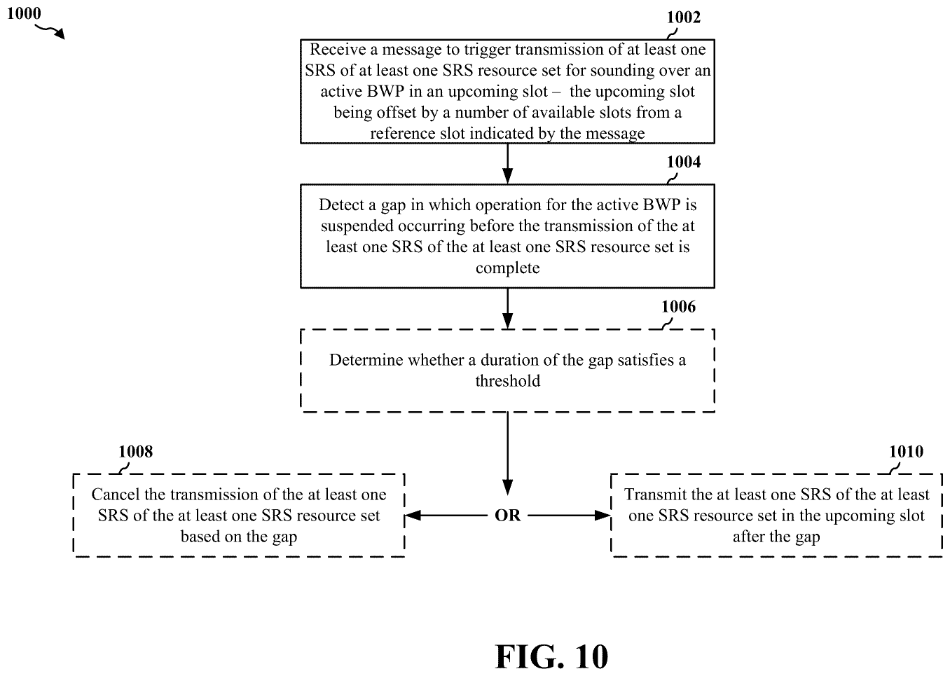

FIG. 10 a flowchart 1000 of a method of wireless communication. The method may be performed by a UE (e.g., the UE 104, the UE 350, the UE 404) and/or another apparatus (e.g., the apparatus 1102). According to various different aspects, one or more of the illustrated operations may be omitted, transposed, and/or contemporaneously performed.

At 1002, the UE receives a message to trigger transmission of at least one SRS of at least one SRS resource set for sounding over an active BWP in an upcoming slot. The upcoming slot may be offset by a number of available slots from a reference slot indicated by the message. According to various aspects, an available slot may be a slot that satisfies a UE timing condition and has a set of uplink resources sufficient to accommodate all of the at least one SRS of the at least one SRS resource set. In some aspects, the message may be included in DCI. In some other aspects, the reference slot is different from the slot that includes the DCI. In still other aspects, the reference slot may be offset from the slot that includes the DCI. For example, referring to FIG. 4, the UE 404 may receive the DCI 410. Referring to FIGS. 5A through 9, a UE may receive a respective DCI 510, 610, 710, 810, 910.

At 1004, the UE detects a gap in which operation for the active BWP is suspended occurring before the transmission of the at least one SRS of the at least one SRS resource set is complete. In some aspects, the gap may include at least one of a measurement gap associated with measurement reporting in frequency resources outside the active BWP, a first time period in which the active BWP is deactivated and another BWP is activated, a second time period for sounding over a set of component carriers outside of the active BWP, a third time period for sidelink communication on a sidelink BWP, a fourth time period in which no TX chain is available for the transmission of the at least one SRS, or an off duration of a DRX cycle. In some other aspects, the gap may occur during the transmission of the at least one SRS of the at least one SRS resource set. For example, referring to FIG. 4, the UE 404 may detect a gap before completion of transmission of the SRS resource set 412. Referring to FIGS. 6 through 9, a UE may detect a gap 632, 732, 832, 932 in which operation for the active BWP 615, 715, 815, 915 is suspended occurring before the transmission of the at least one SRS of the at least one SRS resource set 612, 712, 812, 912 is complete.

At 1006, the UE may determine whether a duration of the gap satisfies a threshold. The threshold may include one of a threshold value defined by a wireless standard for an access network in which the UE operates or at least one of a threshold number of slots or a respective number of milliseconds that is based on a UE capability. For example, referring to FIG. 4, the UE 404 may determine whether a duration of the gap satisfies a threshold. Referring to FIGS. 6 through 9, a UE may determine whether a duration of the gap 632, 732, 832, 932 satisfies a threshold.

In some aspects, at 1008, the UE may cancel the transmission of the at least one SRS based on the gap. For example, the UE may cancel the transmission of the at least one SRS upon determining that the duration satisfies the threshold. For example, referring to FIG. 4, the UE 404 may cancel the transmission of the at least one SRS 412 based on the gap. Referring to FIGS. 6 through 9, a UE may cancel the transmission of the at least one SRS 612, 712, 812, 912 based on the gap 632, 732, 832, 932.

In some other aspects, at 1010, the UE may transmit SRS of at least one SRS resource set. In some aspects, the UE may transmit the SRS of the at least one SRS resource set after the gap is complete. In some other aspects, the UE may transmit the SRS of the at least one SRS resource set before the gap, and the UE may either resume transmitting the remaining SRS (e.g., SRS repetitions) upon the gap reaching an end, or the UE may cancel the remaining SRS (e.g., SRS repetitions) upon reaching the beginning of the gap. For example, referring to FIG. 4, the UE 404 may transmit SRS of at least one SRS resource set 412. Referring to FIGS. 6 through 9, a UE may transmit at least one SRS of at least one SRS resource set 612. 712, 812, 912 either before or after the gap 632, 732, 832, 932.

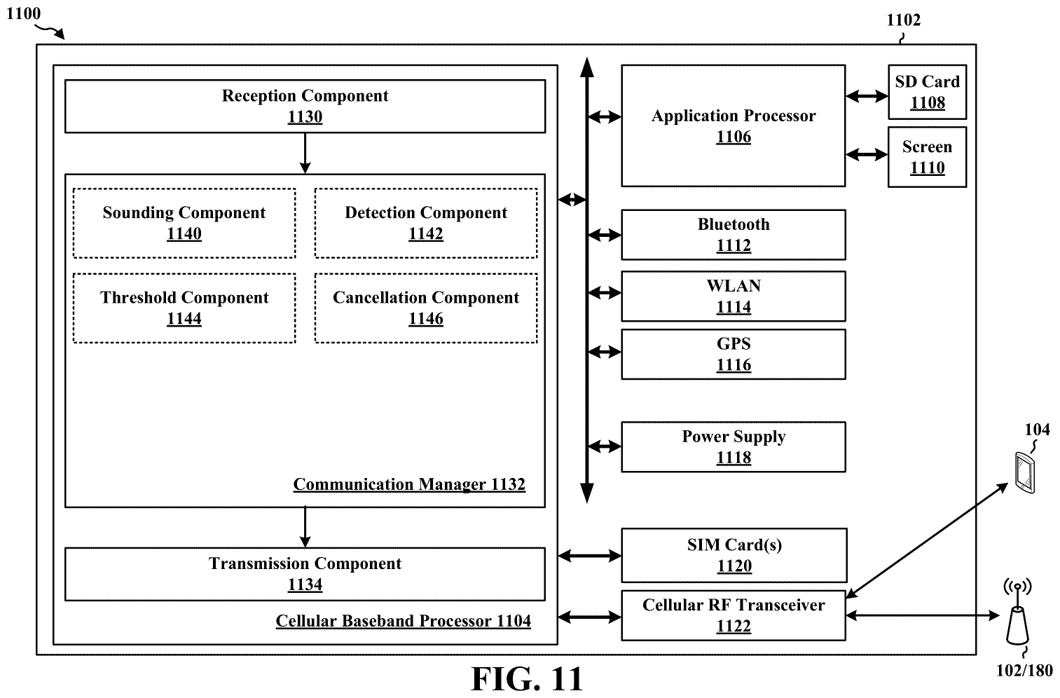

FIG. 11 is a diagram 1100 illustrating an example of a hardware implementation for an apparatus 1102. The apparatus 1102 may be a UE or similar device, or the apparatus 1102 may be a component of a UE or similar device. The apparatus 1102 may include a cellular baseband processor 1104 (also referred to as a modem) and/or a cellular RF transceiver 1122, which may be coupled together and/or integrated into the same package or module.

In some aspects, the apparatus 1102 may accept or may include one or more subscriber identity modules (SIM) cards 1120, which may include one or more integrated circuits, chips, or similar circuitry, and which may be removable or embedded. The one or more SIM cards 1120 may carry identification and/or authentication information, such as an international mobile subscriber identity (IMSI) and/or IMSI-related key(s). Further, the apparatus 1102 may include one or more of an application processor 1106 coupled to a secure digital (SD) card 1108 and a screen 1110, a Bluetooth module 1112, a wireless local area network (WLAN) module 1114, a Global Positioning System (GPS) module 1116, and/or a power supply 1118.

The cellular baseband processor 1104 communicates through the cellular RF transceiver 1122 with the UE 104 and/or base station 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104.

In the context of FIG. 3, the cellular baseband processor 1104 may be a component of the UE 350 and may include the memory 360 and/or at least one of the TX processor 368, the RX processor 356, and/or the controller/processor 359. In one configuration, the apparatus 1102 may be a modem chip and/or may be implemented as the baseband processor 1104, while in another configuration, the apparatus 1102 may be the entire UE (e.g., the UE 350 of FIG. 3) and may include some or all of the abovementioned modules, components, and/or circuitry illustrated in the context of the apparatus 1102. In one configuration, the cellular RF transceiver 1122 may be implemented as at least one of the transmitter 354TX and/or the receiver 354RX.

The reception component 1130 may be configured to receive signaling on a wireless channel, such as signaling from a base station 102/180 or UE 104. The transmission component 1134 may be configured to transmit signaling on a wireless channel, such as signaling to a base station 102/180 or UE 104. The communication manager 1132 may coordinate or manage some or all wireless communications by the apparatus 1102, including across the reception component 1130 and the transmission component 1134.

The reception component 1130 may provide some or all data and/or control information included in received signaling to the communication manager 1132, and the communication manager 1132 may generate and provide some or all of the data and/or control information to be included in transmitted signaling to the transmission component 1134. The communication manager 1132 may include the various illustrated components, including one or more configured to process received data and/or control information, as well as one or more configured to generate data and/or control information for transmission.

The communication manager 1132 may include a sounding component 1140 configured to receive (e.g., from the base station 102/180 through the reception component 1130) a message to trigger transmission of at least one SRS of at least one SRS resource set for sounding over an active BWP in an upcoming slot, e.g., as described in connection with 1002 of FIG. 10. The upcoming slot may be offset by a number of available slots from a reference slot indicated by the message. According to various aspects, an available slot may be a slot that satisfies a timing condition of the apparatus 1102 and has a set of uplink resources sufficient to accommodate all of the at least one SRS of the at least one SRS resource set. In some aspects, the message may be included in DCI. In some other aspects, the reference slot is different from the slot that includes the DCI. In still other aspects, the reference slot may be offset from the slot that includes the DCI.

The communication manager 1132 may further include a detection component 1142 configured to detect a gap in which operation for the active BWP is suspended occurring before the transmission of the at least one SRS of the at least one SRS resource set is complete, e.g., as described in connection with 1004 of FIG. 10. In some aspects, the gap may include at least one of a measurement gap associated with measurement reporting in frequency resources outside the active BWP, a first time period in which the active BWP is deactivated and another BWP is activated, a second time period for sounding over a set of component carriers outside of the active BWP, a third time period for sidelink communication on a sidelink BWP, a fourth time period in which no TX chain is available for the transmission of the at least one SRS, or an off duration of a DRX cycle. In some aspects, the gap may occur during the transmission of the at least one SRS of the at least one SRS resource set.

The communication manager 1132 may further include a threshold component 1144 configured to determine whether a duration of the gap satisfies a threshold, e.g., as described in connection with 1006 of FIG. 10. The threshold may include one of (1) a threshold value defined by a wireless standard for an access network in which the apparatus 1102 operates: or (2) at least one of a threshold number of slots or a respective number of milliseconds that is based on a capability of the apparatus 1102.

The communication manager 1132 may further include a cancellation component 1146 configured to cancel the transmission of the at least one SRS upon determining that the duration satisfies the threshold, e.g., as described in connection with 1008 of FIG. 10.

In some other aspects, the sounding component 1140 may be further configured to transmit (e.g., through the transmission component 1134) SRS of at least one SRS resource set, e.g., as described in connection with 1010 of FIG. 10. In some aspects, the sounding component 1140 may transmit the SRS of the at least one SRS resource set after the gap is complete. In some other aspects, the sounding component 1140 may transmit the SRS of the at least one SRS resource set before the gap, and the sounding component 1140 may either resume transmitting the remaining SRS (e.g., SRS repetitions) upon the gap reaching an end, or the cancellation component 1146 may be further configured to cancel the remaining SRS (e.g., SRS repetitions) upon reaching the beginning of the gap.

The apparatus 1102 may include additional components that perform some or all of the blocks, operations, signaling, etc. of the algorithm(s) in the aforementioned call flow diagrams and/or flowcharts of FIGS. 4 and 10. As such, some or all of the blocks, operations, signaling, etc. in the aforementioned call flow diagrams and/or flowcharts of FIGS. 4 and 10 may be performed by a component and the apparatus 1102 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes means for receiving a message to trigger transmission of at least one SRS of at least one SRS resource set for sounding over an active BWP in an upcoming slot, the upcoming slot being offset by a number of available slots from a reference slot indicated by the message; and means for detecting a gap in which operation for the active BWP is suspended occurring before the transmission of the at least one SRS of the at least one SRS resource set is complete.

In one configuration, the gap includes at least one of: a measurement gap associated with measurement reporting in frequency resources outside the active BWP, a first time period in which the active BWP is deactivated and another BWP is activated, a second time period for sounding over a set of component carriers outside of the active BWP, a third time period for sidelink communication on a sidelink BWP, a fourth time period in which no TX chain is available for the transmission of the at least one SRS, or an off duration of a DRX cycle.

In one configuration, the apparatus 1102, and in particular the cellular baseband processor 1104, may further include means for transmitting the at least one SRS of the at least one SRS resource set in the upcoming slot after the gap, the number of available slots including a sum of a first number of available slots from the reference slot up to the gap and a second number of available slots after the gap and up to the upcoming slot.

In one configuration, for the UE, every slot that is available occurs outside of the gap, and every slot within the gap is unavailable.

In one configuration, the apparatus 1102, and in particular the cellular baseband processor 1104, may further include means for canceling the transmission of the at least one SRS based on the gap.

In one configuration, the apparatus 1102, and in particular the cellular baseband processor 1104, may further include means for determining whether a duration of the gap satisfies a threshold, with the transmission of the at least one SRS being canceled upon determining that the duration satisfies the threshold.

In one configuration, the gap occurs during the transmission of the at least one SRS of the at least one SRS resource set.

In one configuration, the threshold includes one of a threshold value defined by a wireless standard for an access network in which the UE operates or at least one of a threshold number of slots or a respective number of milliseconds that is based on a UE capability.

In one configuration, the apparatus 1102, and in particular the cellular baseband processor 1104, may further include means for transmitting a first SRS of the at least one SRS in the upcoming slot, the gap occurring after the first SRS is transmitted; and means for canceling transmission of each additional SRS of the at least one SRS from a respective slot of a set of consecutive slots after the gap.

In one configuration, the apparatus 1102, and in particular the cellular baseband processor 1104, may further include means for transmitting a first SRS of the at least one SRS in the upcoming slot, the gap occurring after the first SRS is transmitted; and means for transmitting each remaining SRS of the at least one SRS in a respective slot of a set of consecutive slots after the gap.

In one configuration, an available slot includes a slot that satisfies a UE timing condition and has a set of uplink resources sufficient to accommodate all of the at least one SRS of the at least one SRS resource set.

In one configuration, the message is included in DCI.

In one configuration, the reference slot is different from the slot that includes the DCI.

In one configuration, the reference slot is offset from the slot that includes the DCI.

The aforementioned means may be one or more of the aforementioned components of the apparatus 1102 configured to perform the functions recited by the aforementioned means. As described supra, the apparatus 1102 may include the TX

Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The following examples are illustrative only and may be combined with aspects of other embodiments or teachings described herein, without limitation.

Example 1 is an apparatus for wireless communication at a UE, including: a processor: memory coupled with the processor; and instructions stored in the memory and operable, when executed by the processor, to cause the apparatus to: receive a message to trigger transmission of at least one SRS of at least one SRS resource set for sounding over an active BWP in an upcoming slot, the upcoming slot being offset by a number of available slots from a reference slot indicated by the message; and detect a gap in which operation for the active BWP is suspended occurring before the transmission of the at least one SRS of the at least one SRS resource set is complete.

Example 2 is the apparatus of example 1, with the gap includes at least one of: a measurement gap associated with measurement reporting in frequency resources outside the active BWP, a first time period in which the active BWP is deactivated and another BWP is activated, a second time period for sounding over a set of component carriers outside of the active BWP, a third time period for sidelink communication on a sidelink BWP, a fourth time period in which no TX chain is available for the transmission of the at least one SRS, or an off duration of a DRX cycle.

Example 3 is the apparatus of any of examples 1 or 2, with the instructions, when executed by the processor, are further operable to cause the processor to: transmit the at least one SRS of the at least one SRS resource set in the upcoming slot after the gap, the number of available slots including a sum of a first number of available slots from the reference slot up to the gap and a second number of available slots after the gap and up to the upcoming slot.

Example 4 is the apparatus of example 3, for the UE, every slot that is available occurs outside of the gap, and every slot within the gap is unavailable.

Example 5 is the apparatus of any of examples 1 or 2, with the instructions, when executed by the processor, are further operable to cause the processor to: cancel the transmission of the at least one SRS based on the gap.

Example 6 is the apparatus of example 5, with the instructions, when executed by the processor, are further operable to cause the processor to: determine whether a duration of the gap satisfies a threshold, the transmission of the at least one SRS being canceled upon a determination that the duration satisfies the threshold.

Example 7 is the apparatus of example 6, with the gap occurring during the transmission of the at least one SRS of the at least one SRS resource set.

Example 8 is the apparatus of any of examples 6 or 7, with the threshold includes one of a threshold value defined by a wireless standard for an access network in which the UE operates or at least one of a threshold number of slots or a respective number of milliseconds that is based on a UE capability.

Example 9 is the apparatus of any of examples 1 to 5, with the instructions, when executed by the processor, are further operable to cause the processor to: transmit a first SRS of the at least one SRS in the upcoming slot, the gap occurring after the first SRS is transmitted; and cancel transmission of each additional SRS of the at least one SRS from a respective slot of a set of consecutive slots after the gap.

Example 10 is the apparatus of any of examples 1 to 4, with the instructions, when executed by the processor, are further operable to cause the processor to: transmit a first SRS of the at least one SRS in the upcoming slot, the gap occurring after the first SRS is transmitted; and transmit each remaining SRS of the at least one SRS in a respective slot of a set of consecutive slots after the gap.

Example 11 is the apparatus of any of examples 1 to 10, with an available slot includes a slot that satisfies a UE timing condition and has a set of uplink resources sufficient to accommodate all of the at least one SRS of the at least one SRS resource set.

Example 12 is the apparatus of any of examples 1 to 11, with the message is included in DCI.

Example 13 is the apparatus of example 12, with the reference slot is different from the slot that includes the DCI.

Example 14 is the apparatus of any of examples 12 or 13, with the reference slot is offset from the slot that includes the DCI.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication by a user equipment (UE), comprising:
receiving a message to trigger transmission of at least one sounding reference signal (SRS) of at least one SRS resource set for sounding over an active bandwidth part (BWP) in an upcoming slot, the upcoming slot being offset by a number of available slots from a reference slot indicated by the message; and
detecting a gap in which operation for the active BWP is suspended occurring before the transmission of the at least one SRS of the at least one SRS resource set is complete.

2. The method of claim 1, wherein the gap comprises at least one of:
a measurement gap associated with measurement reporting in frequency resources outside the active BWP,
a first time period in which the active BWP is deactivated and another BWP is activated,
a second time period for sounding over a set of component carriers outside of the active BWP,
a third time period for sidelink communication on a sidelink BWP,
a fourth time period in which no transmit (TX) chain is available for the transmission of the at least one SRS, or
an off duration of a discontinuous reception (DRX) cycle.

3. The method of claim 1, further comprising:
transmitting the at least one SRS of the at least one SRS resource set in the upcoming slot after the gap,
the number of available slots comprising a sum of a first number of available slots from the reference slot up to the gap and a second number of available slots after the gap and up to the upcoming slot.

4. The method of claim 3, wherein, for the UE, every slot that is available occurs outside of the gap, and every slot within the gap is unavailable.

5. The method of claim 1, further comprising:
canceling the transmission of the at least one SRS based on the gap.

6. The method of claim 5, further comprising:
determining whether a duration of the gap satisfies a threshold,
the transmission of the at least one SRS being canceled upon determining that the duration satisfies the threshold.

7. The method of claim 6, wherein the gap occurs during the transmission of the at least one SRS of the at least one SRS resource set.

8. The method of claim 6, wherein the threshold comprises one of a threshold value defined by a wireless standard for an access network in which the UE operates or at least one of a threshold number of slots or a respective number of milliseconds that is based on a UE capability.

9. The method of claim 1, further comprising:
transmitting a first SRS of the at least one SRS in the upcoming slot, the gap occurring after the first SRS is transmitted; and
canceling transmission of each additional SRS of the at least one SRS from a respective slot of a set of consecutive slots after the gap.

10. The method of claim 1, further comprising:
transmitting a first SRS of the at least one SRS in the upcoming slot, the gap occurring after the first SRS is transmitted; and
transmitting each remaining SRS of the at least one SRS in a respective slot of a set of consecutive slots after the gap.

11. The method of claim 1, wherein an available slot comprises a slot that satisfies a UE timing condition and has a set of uplink resources sufficient to accommodate all of the at least one SRS of the at least one SRS resource set.

12. The method of claim 1, wherein the message is included in downlink control information (DCI).

13. The method of claim 12, wherein the reference slot is different from the slot that includes the DCI.

14. The method of claim 13, wherein the reference slot is offset from the slot that includes the DCI.

15. An apparatus for wireless communication at a user equipment (UE), comprising:
a processor;
memory coupled with the processor; and
instructions stored in the memory and operable, when executed by the processor, to cause the apparatus to:
receive a message to trigger transmission of at least one sounding reference signal (SRS) of at least one SRS resource set for sounding over an active bandwidth part (BWP) in an upcoming slot, the upcoming slot being offset by a number of available slots from a reference slot indicated by the message; and
detect a gap in which operation for the active BWP is suspended occurring before the transmission of the at least one SRS of the at least one SRS resource set is complete.

16. The apparatus of claim 15, wherein the gap comprises at least one of:
a measurement gap associated with measurement reporting in frequency resources outside the active BWP,
a first time period in which the active BWP is deactivated and another BWP is activated,
a second time period for sounding over a set of component carriers outside of the active BWP,
a third time period for sidelink communication on a sidelink BWP,
a fourth time period in which no transmit (TX) chain is available for the transmission of the at least one SRS, or
an off duration of a discontinuous reception (DRX) cycle.

17. The apparatus of claim 15, wherein the instructions, when executed by the processor, are further operable to cause the processor to:
transmit the at least one SRS of the at least one SRS resource set in the upcoming slot after the gap,
the number of available slots comprising a sum of a first number of available slots from the reference slot up to the gap and a second number of available slots after the gap and up to the upcoming slot.

18. The apparatus of claim 17, wherein, for the UE, every slot that is available occurs outside of the gap, and every slot within the gap is unavailable.

19. The apparatus of claim 15, wherein the instructions, when executed by the processor, are further operable to cause the processor to:
cancel the transmission of the at least one SRS based on the gap.

20. The apparatus of claim 19, wherein the instructions, when executed by the processor, are further operable to cause the processor to:
determine whether a duration of the gap satisfies a threshold,
the transmission of the at least one SRS being canceled upon a determination that the duration satisfies the threshold.

21. The apparatus of claim 20, wherein the gap occurs during the transmission of the at least one SRS of the at least one SRS resource set.

22. The apparatus of claim 21, wherein the threshold comprises one of a threshold value defined by a wireless standard for an access network in which the UE operates or at least one of a threshold number of slots or a respective number of milliseconds that is based on a UE capability.

23. The apparatus of claim 15, wherein the instructions, when executed by the processor, arc further operable to cause the processor to:
transmit a first SRS of the at least one SRS in the upcoming slot, the gap occurring after the first SRS is transmitted; and
cancel transmission of each additional SRS of the at least one SRS from a respective slot of a set of consecutive slots after the gap.

24. The apparatus of claim 15, wherein the instructions, when executed by the processor, are further operable to cause the processor to:
transmit a first SRS of the at least one SRS in the upcoming slot, the gap occurring after the first SRS is transmitted; and
transmit each remaining SRS of the at least one SRS in a respective slot of a set of consecutive slots after the gap.

25. The apparatus of claim 15, wherein an available slot comprises a slot that satisfies a UE timing condition and has a set of uplink resources sufficient to accommodate all of the at least one SRS of the at least one SRS resource set.

26. The apparatus of claim 15, wherein the message is included in downlink control information (DCI).

27. The apparatus of claim 26, wherein the reference slot is different from the slot that includes the DCI.

28. The apparatus of claim 27, wherein the reference slot is offset from the slot that includes the DCI.

29. An apparatus for wireless communication for wireless communication at a user equipment (UE), comprising:
means for receiving a message to trigger transmission of at least one sounding reference signal (SRS) of at least one SRS resource set for sounding over an active bandwidth part (BWP) in an upcoming slot, the upcoming slot being offset by a number of available slots from a reference slot indicated by the message; and
means for detecting a gap in which operation for the active BWP is suspended occurring before the transmission of the at least one SRS of the at least one SRS resource set is complete.

30. The apparatus of claim 29, wherein the gap comprises at least one of:
a measurement gap associated with measurement reporting in frequency resources outside the active BWP,
a first time period in which the active BWP is deactivated and another BWP is activated,
a second time period for sounding over a set of component carriers outside of the active BWP,
a third time period for sidelink communication on a sidelink BWP,
a fourth time period in which no transmit (TX) chain is available for the transmission of the at least one SRS, or
an off duration of a discontinuous reception (DRX) cycle.

31. The apparatus of claim 29, further comprising:
means for transmitting the at least one SRS of the at least one SRS resource set in the upcoming slot after the gap,
the number of available slots comprising a sum of a first number of available slots from the reference slot up to the gap and a second number of available slots after the gap and up to the upcoming slot.

32. The apparatus of claim 31, wherein, for the UE, every slot that is available occurs outside of the gap, and every slot within the gap is unavailable.

33. The apparatus of claim 29, further comprising:
means for canceling the transmission of the at least one SRS based on the gap.

34. The apparatus of claim 33, further comprising:
means for determining whether a duration of the gap satisfies a threshold,
the transmission of the at least one SRS being canceled upon determining that the duration satisfies the threshold.

35. The apparatus of claim 34, wherein the gap occurs during the transmission of the at least one SRS of the at least one SRS resource set.
